(19) United States
(12) Patent Application Publication
(10) Pub. No.: US 2007/0019930 A1
(43) Pub. Date: Jan. 25, 2007

(54) Image display device and method of recording broadcasting program

(75) Inventor: Yong Chul Kim, Gwangjoo-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/488,822

(22) Filed: Jul. 19, 2006

(30) Foreign Application Priority Data
Jul. 20, 2005 (KR) 10-2005-0065824

(51) Int. Cl. H04N 7/00

(52) U.S. Cl. 386/95

(57) ABSTRACT

An image display device and a method of recording broadcasting program are provided. The image display device includes a signal processing unit receiving and processing a broadcasting signal, a storage unit storing the broadcasting signal, an outputting unit decoding and outputting the broadcasting signal, and a control unit analyzing PID (program identification) information in the broadcasting signal to determine whether a commercial broadcast is included in the broadcasting signal or not, and controlling to record a selected broadcasting program without the commercial broadcast.

### BACKGROUND OF THE INVENTION 1. Field of the Invention

The present invention relates to an image display device and a method of recording a broadcasting program. 2. Description of the Related Art

Consumers are more and more interested in a digital television using a digital transmission method.

The digital television has functions that record a broadcasting program in real-time and play the recorded broadcasting program at a desired time by using a personal video recorder (PVR) while watching the broadcasting program.

A PVR system is a personal digital video recorder that records and plays information to and from a hard disk. Unlike VCRs that record an image signal on a magnetic tape, the PVR system is a new concept digital recorder that records and plays information to and from a hard disk. That is, the PVR system is a next generation recorder that can record a broadcasting program with a large-sized data through a hard disk drive (HDD) built in a set top box or a television.

However, an image display device using a related art PVR system records a broadcasting program with commercial broadcasts in a corresponding channel from a recording start point to a recording end point when using timer recording or directly inputting a recording command to record a broadcasting program.

Especially, two or four commercial broadcasts are inserted between the recording start point and the recording end point in the broadcasting program. Since additional commercial broadcast information is not included in an electronic program guide (EPG) information, it is regarded as a portion of the broadcasting program that will be recorded. Thus, the commercial broadcasts are recorded while recording the broadcasting program.

Since the broadcasting program with the commercial broadcasts is recorded, a user watches unwanted commercial broadcasts, and also capacity of storage medium such as a hard disk is wasted due to the commercial broadcasts.

### SUMMARY OF THE INVENTION

Accordingly, the present invention is directed to an image display device and a method of recording a broadcasting program that substantially obviate one or more problems due to limitations and disadvantages of the related art.

An object of the present invention is to provide an image display device and a method of recording a broadcasting program. Commercial broadcasts in a broadcasting program are deleted or not stored through the image display device and the method. Thus, a user can watch the broadcasting program without the commercial broadcasts, and also capacity of storage medium such as a hard disk can be saved.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an image display device including: a signal processing unit receiving and processing a broadcasting signal; a storage unit storing the broadcasting signal; an outputting unit decoding and outputting the broadcasting signal; and a control unit analyzing PID (program identification) information in the broadcasting signal to determine whether a commercial broadcast is included in the broadcasting signal or not, and controlling to record a selected broadcasting program without the commercial broadcast.

In another aspect of the present invention, there is provided a method of recording a broadcasting program, the method including: recording a broadcasting signal; detecting and analyzing PID from a received broadcasting signal; and not storing a transport stream (TS) packet of the PID according to the PID analysis result.

In a further another aspect of the present invention, there is provided a method of recording a broadcasting program, the method including: storing a broadcasting signal; detecting and analyzing PID from the stored broadcasting signal; and deleting a TS packet of the PID according to the PID analysis result.

In a still further another aspect of the present invention, there is provided a method of recording a broadcasting program, the method including: storing a broadcasting signal; analyzing the stored broadcasting signal; and deleting a commercial broadcast in the broadcasting signal according to the broadcasting signal analysis result.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view of a configuration of an image display device;

FIG. 2 is a flowchart illustrating a method of recording a broadcasting program in an image display device according to one embodiment of the present invention; and

FIG. 3 is a flowchart illustrating a method of recording a broadcasting program in an image display device according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

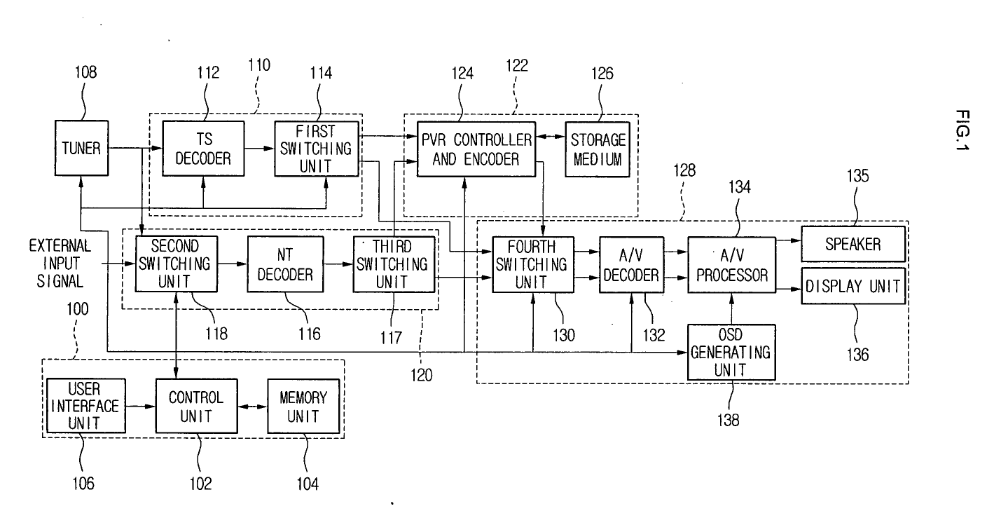

FIG. 1 is a view of a configuration of an image display device.

Referring to FIG. 1, the image display device includes a command processing unit 100, a tuner 108, a first signal processing unit 110, a second signal processing unit 120, a storage unit 122, and an outputting unit 128. The command processing unit 100 receives and processes commands such as switching a channel, recoding a broadcasting program, plying a recorded broadcasting program, etc. The tuner 108 selects and receives a channel that a user wants in broadcasting signals. The first signal processing unit 110 receives and processes a digital broadcasting signal in the broadcasting signals received through the tuner 108. The second signal processing unit 120 processes an analog broadcasting signal or an external input signal in the broadcasting signals received through the tuner 108. The storage unit 122 stores the broadcasting signals processed in the first signal processing unit 110 and the second signal processing unit 120. Moreover, the outputting unit 128 receives, processes, and outputs the broadcasting signals processed in the first signal processing unit 110 and the second signal processing unit 120, and the broadcasting signals played from the storage unit 122.

The command processing unit 100 includes a user interfacing unit 106 receiving user commands, a control unit 102 records a received broadcasting signal or plays and outputs a recorded broadcasting signal according to the command inputted through the user interfacing unit 106, and a memory unit stores various information such as a user information, a timer recording, etc.

The control unit 102 controls the first signal processing unit 110, the second signal processing unit 120, the storage unit 122, and the outputting unit 128 to manage storing and displaying broadcasting programs as follows.

The first signal processing unit 110 includes a transport stream (TS) decoder 112 receiving and decoding a digital broadcasting signal from the tuner 108, and a first switching unit 114 selectively outputs the signal decoded in the TS decoder 112 into the storage unit 122 and the outputting unit 128 according to a control signal of the controller 102.

Additionally, the second signal processing unit 120 includes a second switching unit 118 selecting an analog broadcasting signal received from the tuner 108, and an external input signal inputted from external devices, an NT decoder 116 decoding the signal switched in the second switching unit 118, and a third switching unit 114 selectively outputting the signal decoded in the NT decoder 116 into the storage unit 122 or the outputting unit 128. The NT decoder 116 decodes NTSC signal.

The storage unit 122 includes a PVR controller and an encoder 124 receiving and encoding outputs of the first switching unit 114 or the third switching unit 117, and a storage medium 126 storing the signals encoded in the PVR controller and the encoder 124. The storage medium 126 can be formed of various medium such as a hard disk, non-volatile memory, etc.

The outputting unit 128 includes a fourth switching unit 130 selecting outputs of the first switching unit 114, the second switching unit 117, and the PVR controller and the encoder 124, an AV decoder 132 decoding audio and video signals selected from the fourth switching unit 130, an AV processor 134 processing the signal decoded in the AV decoder 132 to output sound and video, a speaker 135 outputting audio signals processed in the AV processor 134, a display unit 136 outputting a video signals processed in the AV processor 134, and an OSD generating unit 138 generating an OSD screen to select recording and playing conditions that a user want and display recoding and playing state.

In the image display device of the present invention, the control unit 102 analyzes a received broadcasting signal to control the commercial broadcasts not to be stored in the storage medium 126, or to delete the commercial broadcasts in the storage medium 126 while recording a broadcasting program.

A Program Specific Information (PSI) provides the program specification information for which program to select from a plurality of programs, which packet to select, and how to decode the selected packet. The PSI is formed of four tables.

The PSI is special information this is transmitted by a packet in which program identification (PID) is ‘0’. The PSI includes a program association table (PAT), a program map table (PMT), a conditional access table (CAT), and a network information table (NIT). The PAT includes a PID value of the PMT describing components of each program. The PMT describes attachment information and a PID list of a TS packet that is transmitted with a PID number and each bit string of video, audio, etc., which constitute a program. The CAT is necessary for an authorized user to decode and play the bit string that is applied with scramble for playback restriction. The NIT includes physical network information of a region where information is received.

The present invention identifies commercial broadcasts from broadcasting signals using the PID information to store the broadcasting program without the commercial broadcasts in the storage medium 126.

That is, the control unit 102 extracts the PID information from the broadcasting signal that is separated from the TS decoder 112, and analyzes the PID information. The control unit 102 determines whether the PID information corresponds to the commercial broadcasts or not such that TP packets (corresponding to the PID of the commercial broadcast) are not recorded. That is, when the commercial broadcasts are included in the broadcasting program, they are not recorded.

According to another embodiment, the control unit 102 extracts the PID information from the broadcasting signal stored in the storage medium 126, and determines whether the PID information corresponds to the commercial broadcast or not to delete the TP packet corresponding to the PID of the commercial broadcast. That is, only the commercial broadcasts in the stored broadcasting program are deleted.

Operations of the image display device will be described.

First, the control unit 102 controls the tuner 108 to select a channel according to a power-on command inputted through the user interfacing unit 106.

The broadcasting signal selected through the tuner 108 is inputted to the TS decoder 112 and then divided into video, audio, and broadcasting information.

According to a command inputted through the user interfacing unit 106, the broadcasting signal decoded in the TS decoder 112 can be stored in the storage medium 126.

The control unit 102 determines whether to record the broadcasting program or not according to the PID information extracted from the broadcasting signal. That is, when the commercial broadcast is identified by analyzing the PID information, the corresponding broadcasting program is not stored in the storage medium 126.

Additionally, the control unit 102 extracts the PID information from the stored broadcasting signals and analyzes the PID information to identify commercial broadcasts in stored broadcasting program to delete the corresponding broadcasting program in the storage medium 126.

Accordingly, when a user wants to record a specific broadcasting program, commercial broadcasts in the broadcasting program can be deleted to record the broadcasting program without the commercial broadcasts.

On the other hand, the broadcasting signals processed in the first signal processing unit 110 and the second signal processing unit 120, and the broadcasting signal played in the storage unit 122 are processed to be outputted and displayed through the outputting unit 128.

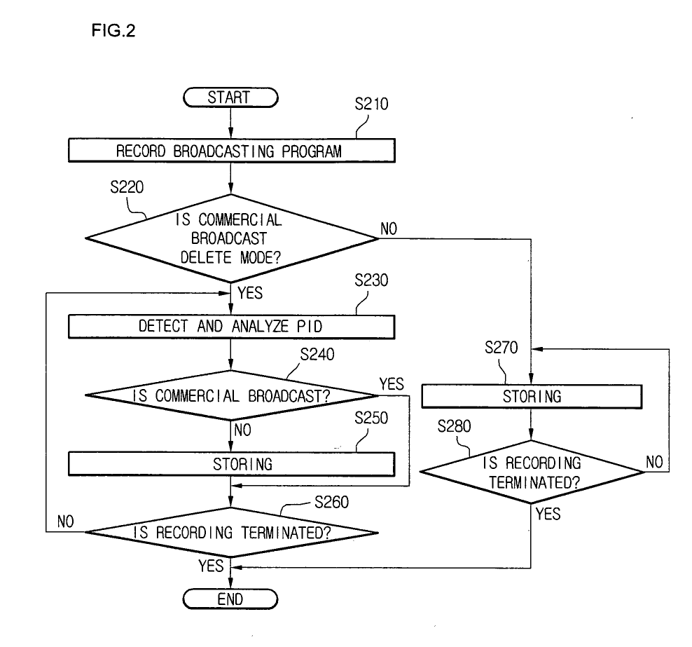

FIG. 2 is a flowchart illustrating a method of recording a broadcasting program in an image display device according to one embodiment of the present invention.

Referring to FIG. 2, when a recording command is inputted, a selected broadcasting program is recorded in operation S210.

In operation S220, a commercial broadcast delete mode is performed according to a user selection or a manufacturing process setting of an image display device.

In operations S230 and S240, when the commercial broadcast delete mode is performed, the image display device detects PID from the received broadcasting signal and determines whether the commercial broadcast is or not.

In operation S250, when the broadcasting signal in recording is not the commercial broadcast, the broadcasting program is stored in the storage medium, and when the broadcasting signals in recording is the commercial broadcast, the broadcasting program is not stored in the storage medium.

On the other hand, when the commercial broadcast delete mode is not performed, the broadcasting program is stored in the storage medium without determining whether the commercial broadcast is or not in operation S270.

The recording of these broadcasting signals continues until a recording end point in operations S260 and S280.

According to the embodiment of FIG. 2, since the image display device detects and analyzes the PID of the broadcasting signal to determine whether to record a broadcasting program or not, the target broadcasting program without the commercial broadcasts can be recorded.

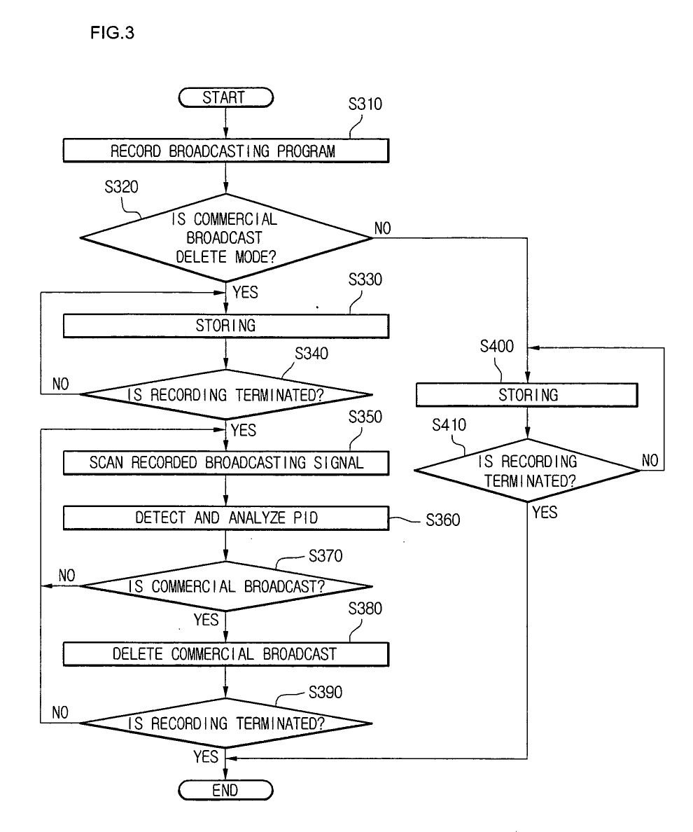

FIG. 3 is a flowchart illustrating a method of recording a broadcasting program in an image display device according to another embodiment of the present invention.

Referring to FIG. 3, when a recording command is inputted, the selected broadcasting program is recorded in operation S310.

In operation S320, a commercial broadcast delete mode is performed according to a user selection or a manufacturing process setting of an image display device.

In operations S400 and S410, when the commercial broadcast delete mode is not selected, the selected broadcasting program is stored until a recording end point.

In operations S330, S340, and S350, when the commercial broadcast delete mode is selected, the selected broadcasting program is stored until the recording end point, and then the recorded broadcasting signal is scanned.

Next, the image device detects the PID from the recorded broadcasting signal and analyzes the PID to determine whether the commercial broadcast is or not in operations S380 and S390.

In operations S380 and S390, the recorded broadcasting signals are scanned to delete the commercial broadcasts when the recorded broadcasting programs include the commercial broadcasts.

On the other hand, after the recording, the broadcasting signals are scanned using the method of recording the broadcasting program as illustrated in FIG. 3. However, the present invention is not limited to scanning for the PID detection after the entire target broadcasting program is stored in the storage medium.

That is, before completing the recording of the broadcasting program, the broadcasting signals that are already stored in the storage medium can be scanned to detect and analyze the PID. When the broadcasting program includes the commercial broadcasts, a corresponding broadcasting signal can be deleted.

According to the image display device and a method of recording a broadcasting program, the commercial broadcasts in the target broadcasting program are deleted or not to be stored in the storage medium. Therefore, a user can watch the broadcasting program without the commercial broadcasts, and also capacity of storage medium such as a hard disk can be saved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An image display device comprising:
a signal processing unit receiving and processing a broadcasting signal;
a storage unit storing the broadcasting signal;
an outputting unit decoding and outputting the broadcasting signal; and
a control unit analyzing PID (program identification) information included in the broadcasting signal to determine whether commercial broadcast is included in the broadcasting signal or not, and controlling a selected broadcasting program without the commercial broadcast to be recorded.

2. The image display device according to claim 1, wherein the control unit stores the selected broadcasting program excluding the commercial broadcast from the received broadcasting signal in the storage unit.

3. The image display device according to claim 1, wherein the control unit deletes the commercial broadcast from the broadcasting signal stored in the storage unit.

4. The image display device according to claim 1, wherein the control unit deletes the commercial broadcast from the broadcasting signal stored in the storage unit after completing the broadcasting program recording.

5. A method of recording a broadcasting program, the method comprising:
recording a broadcasting signal;
detecting and analyzing PID from a received broadcasting signal; and
not storing a TS (transport stream) packet of the PID depending on a result of the analyzing of the PID.

6. The method according to claim 5, further comprising, before the recording of the broadcasting signal, inputting a command for a recording mode selection.

7. The method according to claim 5, further comprising not storing the TS packet when the TS packet of the PID includes a commercial broadcast as a result of the analyzing of the PID.

8. The method according to claim 5, further comprising storing the TS packet when the TS packet of the PID is a target broadcasting program as a result of the analyzing of the PID.

9. A method of recording a broadcasting program, the method comprising:
storing a broadcasting signal;
detecting and analyzing PID from the stored broadcasting signal; and
deleting a TS packet of the PID depending on a result of the analyzing of the PID.

10. The method according to claim 9, further comprising, before the recording of the broadcasting signal, inputting a command for a recording mode selection.

11. The method according to claim 9, further comprising deleting the TS packet when the TS packet of the PID includes a commercial broadcast as a result of the analyzing of the PID.

12. The method according to claim 9, wherein the PID is detected after completing entire target broadcasting signal storing.

13. The method according to claim 9, wherein the PID is detected from a stored broadcasting signal before completing entire target broadcasting signal storing.

14. A method of recording a broadcasting program, the method comprising:
storing a broadcasting signal;
analyzing the stored broadcasting signal; and
deleting a commercial broadcast in the broadcasting signal depending on a result of the analyzing of the stored broadcasting signal.

15. The method according to claim 14, wherein the analyzing of the stored broadcasting signal comprises analyzing PID.

16. The method according to claim 15, wherein the PID is detected after completing entire target broadcasting signal storing.

17. The method according to claim 15, wherein the PID is detected from a stored broadcasting signal before completing entire target broadcasting signal storing.
